(19) United States
(12) Patent Application Publication
(10) Pub. No.: US 2017/0313824 A1
(43) Pub. Date: Nov. 2, 2017

(54) METHOD FOR PREPARING POLYCARBONATE-POLYORGANOSILOXANE COPOLYMER

(71) Applicant: IDEMITSU KOSAN CO., LTD., Tokyo (JP)

(72) Inventors: Yukiko NAGAO, Koto-ku, Tokyo (JP); Toshiyuki YASUDA, Sodegaura-shi, Chiba (JP); Hiroaki MOTEGI, Shunan-shi, Yamaguchi (JP)

(73) Assignee: IDEMITSU KOSAN CO., LTD., Tokyo (JP)

(21) Appl. No.: 15/526,453

(22) PCT Filed: Nov. 17, 2015
(86) PCT No.: PCT/JP2015/082228

§ 371 Date: May 12, 2017

(30) Foreign Application Priority Data
Nov. 17, 2014 (JP) 2014-232876

(51) Int. Cl. C08G 77/448

(52) U.S. Cl. CPC C08G 77/448

(57) ABSTRACT

Provided is a method of producing a polycarbonate-polyorganosiloxane copolymer, including: a first reaction zone into which a polycarbonate oligomer, a polyorganosiloxane, and a caustic alkali are introduced to provide a reaction liquid containing the polycarbonate oligomer that has reacted with the polyorganosiloxane; and a second reaction zone into which the reaction liquid obtained from the first reaction zone, an alkaline aqueous solution of a dihydric phenol, a specific end terminator, and the caustic alkali are introduced to provide a polycondensation reaction liquid, in which a total amount of the caustic alkali to be introduced into the second reaction zone is introduced from an introduction port of the second reaction zone to perform a reaction.

### TECHNICAL FIELD

The present invention relates to a method of producing a polycarbonate-polyorganosiloxane copolymer. More specifically, the present invention relates to a method of producing a polycarbonate-polyorganosiloxane copolymer with high production efficiency through an interfacial polymerization method.

### BACKGROUND ART

A polycarbonate-based resin is a polymer excellent in transparency, heat resistance, and impact resistance and is widely used at present as an engineering plastic in the industrial field.

As a method of producing the polycarbonate-based resin, a method involving allowing an aromatic dihydroxy compound, such as bisphenol A, and phosgene to react directly with each other (interfacial polymerization method) is known as a method of producing a high-quality polycarbonate.

As a method of industrially producing a polycarbonate through an interfacial polymerization method, there is typically adopted a method involving blowing phosgene into an alkaline aqueous solution of a bisphenol to produce a polycarbonate oligomer having a reactive chloroformate group, and further mixing the polycarbonate oligomer and the alkaline aqueous solution of the bisphenol to advance a polycondensation reaction in the presence of a polymerization catalyst, such as a tertiary amine.

The bisphenol serving as a raw material monomer is typically supplied after having been dissolved in aqueous sodium hydroxide. Accordingly, the sodium hydroxide concentration of the resultant solution is adjusted to a predetermined value in a dissolution tank where the bisphenol is dissolved in aqueous sodium hydroxide, and the solution is delivered to each of a polycarbonate oligomer-producing step and a step of subjecting the polycarbonate oligomer to the polycondensation reaction (polycondensation reaction step). The concentration of the bisphenol and the concentration of sodium hydroxide at this time are extremely important in terms of the control of the reaction for the production of the polycarbonate oligomer. Meanwhile, when a polycarbonate resin is produced from the oligomer, an optimum sodium hydroxide concentration differs from the optimum concentration of the solution of the bisphenol in aqueous sodium hydroxide used in the polycarbonate oligomer-producing step, and hence aqueous sodium hydroxide is added to adjust the concentration.

Among the polycarbonate-based resins, a polycarbonate-polyorganosiloxane copolymer (hereinafter sometimes referred to as “PC-POS”) has been attracting attention because of its high impact resistance, high chemical resistance, and high flame retardancy, and the copolymer has been expected to find utilization in a wide variety of fields, such as the field of electrical and electronic equipment and the field of an automobile. As a method of producing the PC-POS, there is known a method involving allowing a dihydric phenol-based compound and phosgene to react with each other to produce a polycarbonate oligomer, and subjecting the polycarbonate oligomer and a polyorganosiloxane (hereinafter sometimes referred to as “POS”) to polycondensation in the presence of methylene chloride, an alkaline compound aqueous solution, a dihydric phenol-based compound, and a polymerization catalyst (see Patent Document 1).

Also in the case of the production of the PC-POS, the bisphenol serving as a raw material monomer is typically supplied after having been dissolved in aqueous sodium hydroxide. Accordingly, the sodium hydroxide concentration of the resultant solution is adjusted to a predetermined value in a dissolution tank where the bisphenol is dissolved in aqueous sodium hydroxide, and the solution is delivered to each of a polycarbonate oligomer-producing step and a step of subjecting the polycarbonate oligomer to the polycondensation reaction (polycondensation reaction step). The optimum concentration of the solution of the bisphenol in aqueous sodium hydroxide to be used in the polycondensation reaction step differs from that of the solution of the bisphenol in aqueous sodium hydroxide used in the polycarbonate oligomer-producing step, and hence aqueous sodium hydroxide is added to adjust the concentration.

The related-art production method for the PC-POS has involved a problem in that the amount of an unreacted POS increases to cause deteriorations in quality, such as a reduction in transparency of the product and a reduction in impact resistance thereof. In view of the foregoing, the following has been proposed as a solution to the problems, such as the reduction in transparency of the product and the reduction in impact resistance thereof (see Patent Document 2). In the polycondensation reaction step of producing the PC-POS from the polycarbonate oligomer, before the alkaline compound aqueous solution containing the dihydric phenol-based compound delivered from the dissolution tank for the dihydric phenol-based compound is brought into contact with the polycarbonate oligomer and the POS, the amount of the unreacted POS is reduced by mixing the solution with the alkaline compound aqueous solution to increase the concentration of the alkaline compound with respect to the dihydric phenol-based compound.

### CITATION LIST

### Patent Document

Patent Document 1: JP 06-329781 A

Patent Document 2: JP 2014-80462 A

### SUMMARY OF INVENTION

### Technical Problem

In the polycondensation reaction step at the time of the production of the PC-POS through the interfacial polymerization method, a caustic alkali needs to be used for accelerating the polycondensation reaction. However, in the case where the caustic alkali is added in the middle of the polycondensation reaction step, there occurs a problem in that when a polycondensation reaction liquid (emulsion solution) to be obtained is separated into an organic phase containing the polycarbonate resin and an aqueous phase, oil-water separability deteriorates to reduce the productivity of the resin.

In view of the problem, an object of the present invention is to provide a method of producing a polycarbonate-polyorganosiloxane copolymer excellent in productivity.

### Solution to Problem

The inventors of the present invention have made extensive investigations, and as a result, have found a method of producing a polycarbonate-polyorganosiloxane copolymer excellent in productivity by devising the timing at which a caustic alkali for accelerating a polycondensation reaction is introduced at the time of the production of a PC-POS through an interfacial polymerization method. Thus, the inventors have completed the present invention.

That is, the present invention relates to the following items [1] to [10].

[1] A method of producing a polycarbonate-polyorganosiloxane copolymer, comprising:

a first reaction zone into which a polycarbonate oligomer, a polyorganosiloxane, and a caustic alkali are introduced to provide a reaction liquid containing the polycarbonate oligomer that has reacted with the polyorganosiloxane; and

a second reaction zone into which the reaction liquid obtained from the first reaction zone, an alkaline aqueous solution of a dihydric phenol, an end terminator represented by the following general formula (I), and the caustic alkali are introduced to provide a polycondensation reaction liquid,

wherein a total amount of the caustic alkali to be introduced into the second reaction zone is introduced from an introduction port of the second reaction zone to perform a reaction:

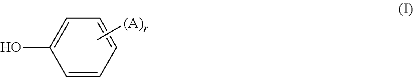

wherein A represents a linear or branched alkyl group having 1 to 14 carbon atoms, or a phenyl group-substituted alkyl group, and r represents from 0 to 5.

[2] The method of producing a polycarbonate-polyorganosiloxane copolymer according to Item [1], wherein the dihydric phenol comprises a dihydric phenol represented by the following general formula (1):

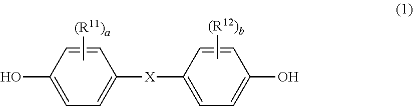

wherein R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

[3] The method of producing a polycarbonate-polyorganosiloxane copolymer according to Item [1] to [2], wherein the polyorganosiloxane comprises a polyorganosiloxane represented by at least one selected from the following general formulae (2), (3), and (4):

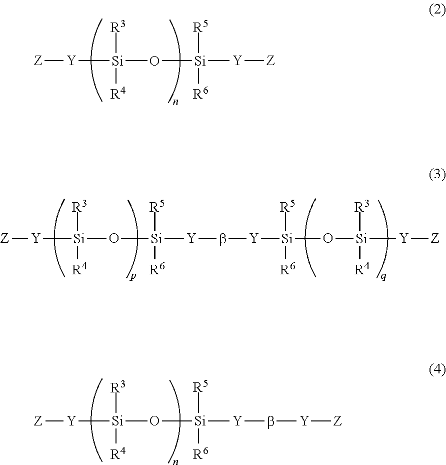

wherein R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴ R⁵, or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, Z represents a hydrogen atom or a halogen atom, and a plurality of Z may be identical to or different from each other, β represents a divalent group derived from a diisocyanate compound, or a divalent group derived from a dicarboxylic acid or a halide of a dicarboxylic acid, p and q each represent an integer of 1 or more, and a sum of p and q is from 20 to 500, and n represents an average number of repetitions of from 20 to 500.

[4] The method of producing a polycarbonate-polyorganosiloxane copolymer according to any one of Items [1] to [3], wherein the end terminator comprises at least one selected from p-t-butylphenol, p-cumylphenol, and p-phenylphenol.

[5] The method of producing a polycarbonate-polyorganosiloxane copolymer according to any one of Items [1] to [4], wherein the dihydric phenol comprises bisphenol A.

[6] The method of producing a polycarbonate-polyorganosiloxane copolymer according to any one of Items [1] to [5], wherein the caustic alkali comprises sodium hydroxide and the alkaline aqueous solution comprises aqueous sodium hydroxide.

[7] The method of producing a polycarbonate-polyorganosiloxane copolymer according to any one of Items [1] to [6], wherein a content of a polyorganosiloxane moiety in the polycarbonate-polyorganosiloxane copolymer is from 1 mass % to 20 mass %.

[8] The method of producing a polycarbonate-polyorganosiloxane copolymer according to any one of Items [1] to [7], wherein the polycarbonate-polyorganosiloxane copolymer has a viscosity-average molecular weight of from 10,000 to 30,000.

[9] The method of producing a polycarbonate-polyorganosiloxane copolymer according to any one of Items [1] to [8], wherein a reactor to be used in the first reaction zone and/or the second reaction zone comprises a line mixer.

[10] The method of producing a polycarbonate-polyorganosiloxane copolymer according to any one of Items [1] to [9], wherein the polycarbonate oligomer to be used in the first reaction zone has a weight-average molecular weight of less than 5,000.

### Advantageous Effects of Invention

According to the present invention, the method of producing a polycarbonate-polyorganosiloxane copolymer excellent in productivity can be provided.

### BRIEF DESCRIPTION OF DRAWINGS

FIG. 1 is a schematic view of a reaction process in a method of producing a polycarbonate-polyorganosiloxane copolymer according to an embodiment of the present invention.

FIG. 2 is a schematic view of a reaction process used in Comparison Example 1.

### DESCRIPTION OF EMBODIMENTS

A method of producing a polycarbonate-polyorganosiloxane copolymer of the present invention comprises: a first reaction zone into which a polycarbonate oligomer, a polyorganosiloxane, and a caustic alkali are introduced to provide a reaction liquid containing the polycarbonate oligomer (hereinafter sometimes referred to as “PC-POS oligomer reaction liquid”) that has reacted with the polyorganosiloxane; and

a second reaction zone into which the reaction liquid obtained from the first reaction zone, an alkaline aqueous solution of a dihydric phenol, an end terminator represented by the following general formula (I), and the caustic alkali are introduced to provide a polycondensation reaction liquid,

wherein a total amount of the caustic alkali to be introduced into the second reaction zone is introduced from an introduction port of the second reaction zone to perform a reaction:

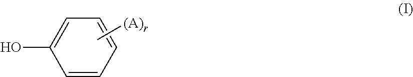

In the general formula (I), A represents a linear or branched alkyl group having 1 to 14 carbon atoms, or a phenyl group-substituted alkyl group, and r represents from 0 to 5. r preferably represents from 1 to 3.

The method of producing a polycarbonate-polyorganosiloxane copolymer of the present invention is described in detail below. In this description, a specification considered to be preferred can be arbitrarily adopted, and a combination of preferred specifications is more preferred.

### [First Reaction Zone]

The first reaction zone specified in the present invention is intended to cause part of the end groups of the polycarbonate oligomer having a weight-average molecular weight of preferably less than 5,000 to react with the polyorganosiloxane to produce the polycarbonate oligomer that has reacted with the polyorganosiloxane. In the first reaction zone, no polycondensation reaction is performed.

<Raw Materials to be used in First Reaction Zone>

### (i) Polycarbonate Oligomer

Although a method of producing the polycarbonate oligomer to be used in the method of producing a polycarbonate-polyorganosiloxane copolymer of the present invention is not particularly limited, for example, the following method can be preferably used.

First, an alkaline aqueous solution of a dihydric phenol is prepared, and the solution is mixed with an organic solvent, such as methylene chloride. While the mixture is stirred, phosgene is subjected to a reaction in the coexistence of the alkaline aqueous solution containing the dihydric phenol and the organic solvent. Thus, the polycarbonate oligomer is obtained.

### (Dihydric Phenol)

The dihydric phenol is preferably a dihydric phenol represented by the following general formula (1):

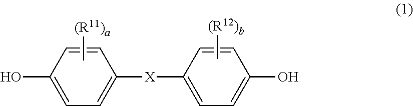

In the general formula (1), R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

Although the dihydric phenol represented by the general formula (1) is not particularly limited, 2,2-bis(4-hydroxyphenyl)propane [trivial name: bisphenol A] is suitable.

Examples of the dihydric phenol except bisphenol A include: bis(hydroxyaryl)alkanes, such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl)naphthylmethane, 1,1-bis(4-hydroxy-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane; bis(hydroxyaryl)cycloalkanes, such as 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane; dihydroxyaryl ethers, such as 4,4′-dihydroxydiphenyl ether and 4,4′-dihydroxy-3,3′-dimethylphenyl ether; dihydroxydiaryl sulfides, such as 4,4′-dihydroxydiphenyl sulfide and 4,4′-dihydroxy-3,3′-dimethyldiphenyl sulfide; dihydroxydiaryl sulfoxides, such as 4,4′-dihydroxydiphenyl sulfoxide and 4,4′-dihydroxy-3,3′-dimethyldiphenyl sulfoxide; dihydroxydiaryl sulfones, such as 4,4′-dihydroxydiphenyl sulfone and 4,4′-dihydroxy-3,3′-dimethyldiphenyl sulfone; dihydroxydiphenyls, such as 4,4′-dihydroxydiphenyl; dihydroxydiarylfluorenes, such as 9,9-bis(4-hydroxyphenyl)fluorene and 9,9-bis(4-hydroxy-3-methylphenyl)fluorene; dihydroxydiaryladamantanes, such as 1,3-bis(4-hydroxyphenyl)adamantane, 2,2-bis(4-hydroxyphenyl)adamantane, and 1,3-bis(4-hydroxyphenyl)-5,7-dimethyladamantane; 4,4′-[1,3-phenylenebis(1-methylethylidene)]bisphenol; 10,10-bis(4-hydroxyphenyl)-9-anthrone; and 1,5-bis(4-hydroxyphenylthio)-2,3-dioxapentane.

One of those dihydric phenols may be used alone, or two or more thereof may be used as a mixture.

### (Alkaline Aqueous Solution)

An alkaline aqueous solution, such as sodium hydroxide or potassium hydroxide, can be preferably used as the alkaline aqueous solution, and a solution having a concentration of from 1 mass % to 15 mass % is preferably used in normal cases. In addition, the content of the dihydric phenol in the alkaline aqueous solution is typically selected from the range of from 0.5 mass % to 20 mass %.

### (Organic Solvent)

The organic solvent to be used in a polycarbonate oligomer production process is, for example, a water-insoluble organic solvent that dissolves the polycarbonate oligomer. Specific examples thereof include halogenated hydrocarbon solvents, such as dichloromethane (methylene chloride), dichloroethane, trichloroethane, tetrachloroethane, pentachloroethane, hexachloroethane, dichloroethylene, chlorobenzene, and dichlorobenzene. Among them, dichloromethane (methylene chloride) is particularly preferred. Further, the usage amount of the organic solvent is desirably selected so that a volume ratio between an organic phase and an aqueous phase maybe from 5/1 to 1/7, preferably from 2/1 to 1/4.

### (Phosgene)

Phosgene to be used in the polycarbonate oligomer production process is a compound obtained by causing chlorine and carbon monoxide to react with each other at a ratio of carbon monoxide of typically from 1.01 mol to 1.3 mol with respect to 1 mol of chlorine through the use of activated carbon as a catalyst. When phosgene is used as a phosgene gas, a phosgene gas containing about 1 vol % to about 30 vol % of unreacted carbon monoxide can be used. Phosgene in a liquefied state can also be used.

### (End Terminator)

In the polycarbonate oligomer production process, the end terminator represented by the general formula (I) can be used for adjusting the molecular weight of the oligomer.

Examples of the end terminator represented by the general formula (I) include phenol, p-cresol, p-tert-butylphenol, p-tert-octylphenol,p-cumylphenol,and p-phenylphenol. Among them, p-tert-butylphenol, p-cumylphenol, and p-phenylphenol are preferred, and p-tert-butylphenol is more preferred.

### (Branching Agent)

Further, in the polycarbonate oligomer production process, a branching agent can be used to introduce a branched structure into the polycarbonate oligomer. The addition amount of the branching agent is preferably from 0.01 mol % to 3 mol %, more preferably from 0.1 mol % to 1.0 mol % with respect to the dihydric phenol.

The branching agent is, for example, a compound having three or more functional groups, such as 1,1,1-tris(4-hydroxyphenyl)ethane, 4,4′-[1-[4-[1-(4-hydroxyphenyl)-1-methylethyl]phenyl]ethyliden e]bisphenol, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, phloroglucin, trimellitic acid, or isatinbis(o-cresol).

In the polycarbonate oligomer production process, the oligomer can be produced continuously or in a batch by using a tank-type reactor as a reactor. A method involving continuously producing the oligomer with a tubular reactor is also a preferred production method.

A reaction temperature is selected from the range of typically from 0° C. to 80° C., preferably from 5° C. to 70° C.

A reaction liquid obtained by the method described above is obtained in an emulsion state formed of an organic phase containing the polycarbonate oligomer having a weight-average molecular weight of less than 5,000 and an aqueous phase containing impurities, such as sodium chloride. The reaction liquid in the emulsion state is subjected to, for example, settled separation to be separated into the organic phase containing the polycarbonate oligomer and the aqueous phase, and the separated organic phase containing the polycarbonate oligomer is used in the first reaction zone. A lower limit for the weight-average molecular weight of the polycarbonate oligomer having a weight-average molecular weight of less than 5,000 is typically about 500. The concentration of a chloroformate end group in the polycarbonate oligomer to be obtained is typically from 0.6 mol/L to 0.9 mol/L.

The polycarbonate oligomer to be used in the first reaction zone is preferably used as the organic phase containing the polycarbonate oligomer having a weight-average molecular weight of less than 5,000. Methylene chloride is preferably used as the organic solvent of the organic phase.

### (ii) Polyorganosiloxane

The polyorganosiloxane to be used in the first reaction zone is preferably a polyorganosiloxane represented by at least one selected from the following general formulae (2), (3), and (4):

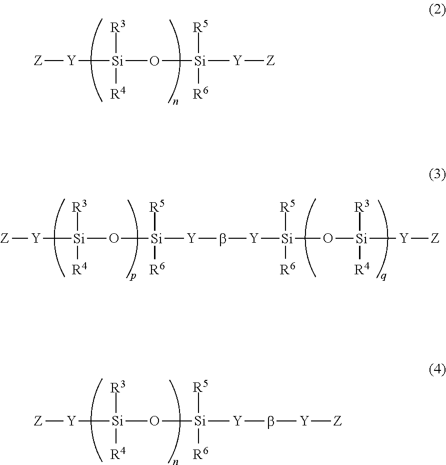

In the general formulae (2), (3), and (4), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵, or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y maybe identical to or different from each other, R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, Z represents a hydrogen atom or a halogen atom, and a plurality of Z may be identical to or different from each other, β represents a divalent group derived from a diisocyanate compound, or a divalent group derived from a dicarboxylic acid or a halide of a dicarboxylic acid, p and q each represent an integer of 1 or more, and a sum of p and q is from 20 to 500, and n represents an average number of repetitions of from 20 to 500.

Examples of the halogen atom that R³ to R⁶ each independently represent include a fluorine atom, a chlorine atom, a bromine atom, and an iodine atom. Examples of the alkyl group that R³ to R⁶ each independently represent include a methyl group, an ethyl group, a n-propyl group, an isopropyl group, various butyl groups (“various” means that a linear group and any branched group are included, and the same applies hereinafter), various pentyl groups, and various hexyl groups. An example of the alkoxy group that R³ to R⁶ each independently represent is an alkoxy group whose alkyl group moiety is the alkyl group described above. Examples of the aryl group that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

The polyorganosiloxane represented by at least one selected from the general formulae (2), (3), and (4) is preferably a polyorganosiloxane in which R³ to R⁶ each represent a methyl group.

The linear or branched alkylene group represented by R⁷ in —R⁷O—, —R⁷COO—, —R⁷NH—, —R⁷NR⁸—, —COO—, —S—, —R⁷COO—R⁹—O—, or —R⁷O—R¹⁰—O— represented by Y is, for example, an alkylene group having 1 to 8 carbon atoms, preferably 1 to 5 carbon atoms, and the cyclic alkylene group represented by R⁷ is, for example, a cycloalkylene group having 5 to 15 carbon atoms, preferably 5 to 10 carbon atoms.

The aryl-substituted alkylene group represented by R⁷ may have a substituent, such as an alkoxy group or an alkyl group, on its aromatic ring, and its specific structure may be, for example, a structure represented by the following general formula (5) or (6). When the polyorganosiloxane has the aryl-substituted alkylene group, the alkylene group is bonded to Si.

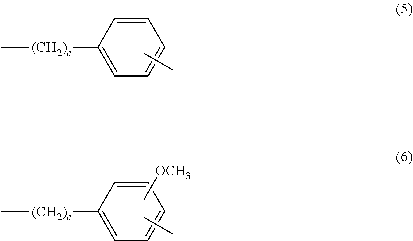

In the general formulae (5) and (6), c represents a positive integer and typically represents an integer of from 1 to 6.

The diarylene group represented by each of R⁷, R⁹, and R¹⁰ refers to a group in which two arylene groups are linked to each other directly or through a divalent organic group, and is specifically a group having a structure represented by —Ar¹—W—Ar²—. Here, Ar¹ and Ar² each represent an arylene group, and W represents a single bond or a divalent organic group. Examples of the divalent organic group represented by W include an isopropylidene group, a methylene group, a dimethylene group, and a trimethylene group.

Examples of the arylene group represented by each of R⁷, Ar¹, and Ar² include arylene groups each having 6 to 14 ring-forming carbon atoms, such as a phenylene group, a naphthylene group, a biphenylene group, and an anthrylene group. Those arylene groups may each have an arbitrary substituent, such as an alkoxy group or an alkyl group.

The alkyl group represented by R⁸ is a linear or branched alkyl group having 1 to 8, preferably 1 to 5 carbon atoms. The alkenyl group represented by R⁸ is, for example, a linear or branched alkenyl group having 2 to 8, preferably 2 to 5 carbon atoms. The aryl group represented by R⁸ is, for example, a phenyl group or a naphthyl group. The aralkyl group represented by R⁸ is, for example, a phenylmethyl group or a phenylethyl group.

The linear, branched, or cyclic alkylene group represented by R¹⁰ is the same as that represented by R⁷.

Y preferably represents —R⁷O—, and R⁷ represents an aryl-substituted alkylene group, in particular a residue of a phenol-based compound having an alkyl group, and more preferably represents an organic residue derived from allylphenol or an organic residue derived from eugenol.

With regard top and q in the general formula (3), it is preferred that p=q, i.e., p=n/2 and q=n/2.

The average number n of repetitions is preferably from 20 to 500, more preferably from 50 to 400, still more preferably from 70 to 300. When the n is 20 or more, the PC-POS can obtain excellent impact resistance, and significant restoration of the impact resistance can be achieved. When the n is 500 or less, handleability at the time of the production of the PC-POS is excellent. The number n of repeating units can be calculated by ¹H-NMR.

In addition, β represents a divalent group derived from a diisocyanate compound, or a divalent group derived from a dicarboxylic acid or a halide of a dicarboxylic acid, and examples thereof include divalent groups represented by the following general formulae (7-1) to (7-5).

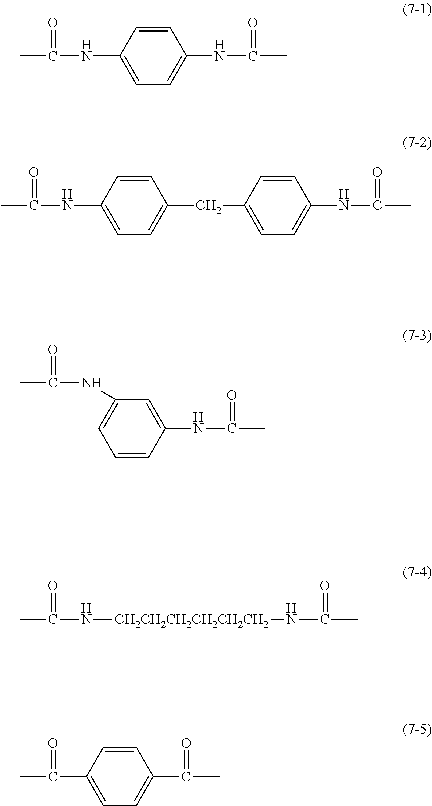

Examples of the polyorganosiloxane represented by the general formula (2) include compounds represented by the following general formulae (2-1) to (2-11):

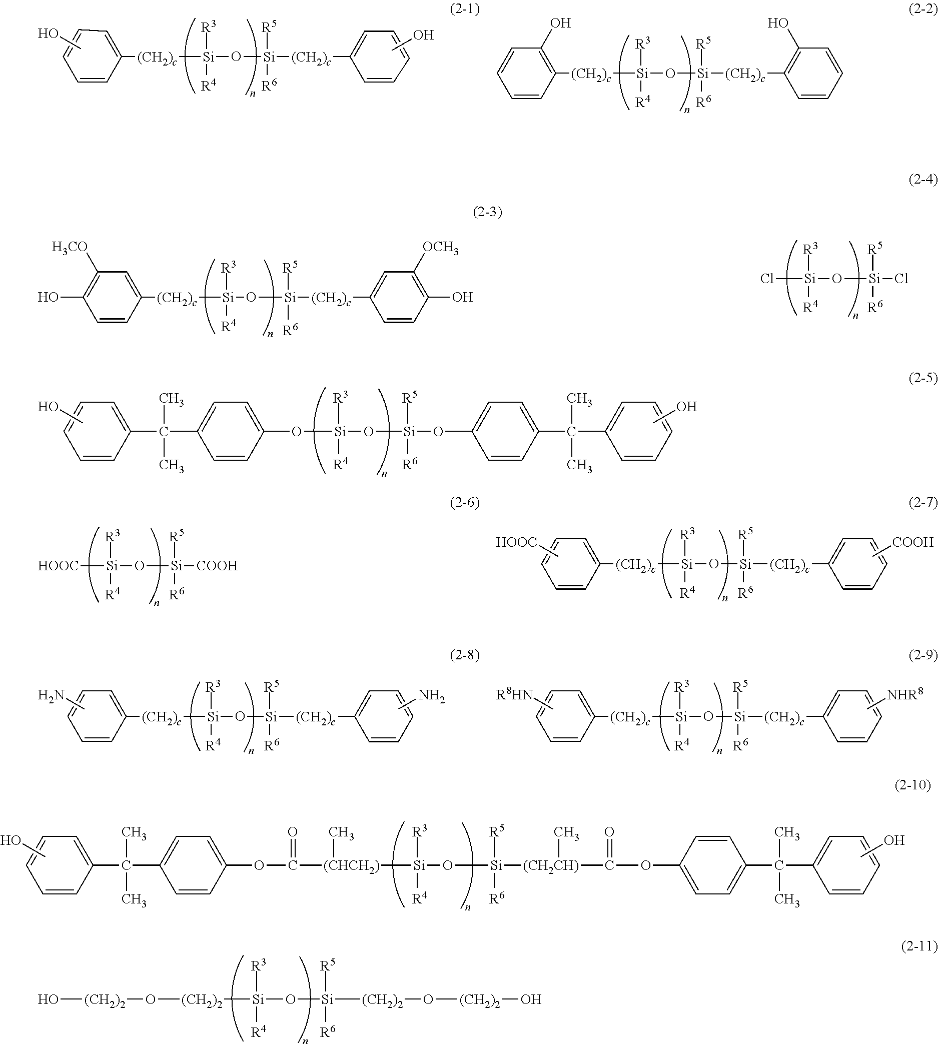

In the general formulae (2-1) to (2-11), R³ to R⁶, n, and R⁸ are as defined above, and preferred groups and values thereof are also the same. c represents a positive integer and typically represents an integer of from 1 to 6.

Among them, a phenol-modified polyorganosiloxane represented by the general formula (2-1) is preferred from the viewpoint of the ease of polymerization. In addition, α, ω-bis [3-(o-hydroxyphenyl)propyl]polydimethylsiloxane as one of the compounds each represented by the general formula (2-2) or α, ω-bis [3-(4-hydroxy-3-methoxyphenyl) propyl]polydimethylsiloxane as one of the compounds each represented by the general formula (2-3) is preferred from the viewpoint of the ease of availability.

When the polyorganosiloxane is introduced into the first reaction zone, the polyorganosiloxane is preferably used after having been dissolved in an organic solvent, preferably methylene chloride because the polyorganosiloxane has low compatibility with the polycarbonate oligomer. When a solution of the polyorganosiloxane in the organic solvent having a specific concentration is prepared in advance, at the time of continuous introduction of the polyorganosiloxane into the first reaction zone, an introduction amount per unit time becomes constant, and hence continuous production in the first reaction zone becomes preferred. In normal cases, the polyorganosiloxane is desirably used at a concentration in the range of from 10 mass % to 30 mass %.

(iii) Caustic Alkali

In order to perform the reaction between the polycarbonate oligomer and the polyorganosiloxane in the first reaction zone, the reaction system needs to be kept alkaline (at a caustic alkali concentration of from 0.05 N to 0.7 N). The caustic alkali to be used is preferably sodium hydroxide or potassium hydroxide. The caustic alkali is preferably introduced as an aqueous solution.

A pipe into which the aqueous solution of the caustic alkali is introduced is preferably warmed in order that the following situation may be avoided: the caustic alkali is deposited in the pipe by a reduction in temperature of the aqueous solution of the caustic alkali, and the deposit clogs the pipe to fluctuate the flow rate of the aqueous solution of the caustic alkali. For example, the mounting of the pipe with a steam tracing or an electric heater is effective, and the electric heater is more preferably used in terms of operation management. The same applies to the caustic alkali to be used in the second reaction zone described later.

### (iv) Other Raw Material

A known catalyst to be used in interfacial polymerization can be used for accelerating the reaction in the first reaction zone. A phase transfer catalyst, such as a tertiary amine or a salt thereof, a quaternary ammonium salt, or a quaternary phosphonium salt, can be preferably used as the catalyst. Examples of the tertiary amine include triethylamine, tributylamine, N,N-dimethylcyclohexylamine, pyridine, and dimethylaniline, and examples of the tertiary amine salt include hydrochloric acid salts and bromic acid salts of the tertiary amines. Examples of the quaternary ammonium salt include trimethylbenzylammonium chloride, triethylbenzylammonium chloride, tributylbenzylammonium chloride, trioctylmethylammonium chloride, tetrabutylammonium chloride, and tetrabutylammonium bromide, and examples of the quaternary phosphonium salt include tetrabutylphosphonium chloride and tetrabutylphosphonium bromide. Each of those catalysts may be used alone, or two or more thereof may be used in combination. Among the catalysts, tertiary amines are preferred, and triethylamine is particularly suitable. Each of those catalysts can be introduced as it is or after having been dissolved in an organic solvent or water when the catalyst is in a liquid state. When the catalyst is in a solid state, each of those catalysts can be introduced after having been dissolved in an organic solvent or water.

<Reactor to be used in First Reaction Zone and Reaction Condition>

The reaction liquid can be produced continuously or in a batch by using a line mixer, a static mixer, an orifice mixer, a stirring tank, or the like as a reactor to be used in the first reaction zone. Those reactors may be arbitrarily combined to be used as a plurality of reactors. In particular, the line mixer among those reactors is preferably used because the reaction liquid can be continuously produced and hence the reaction can be efficiently advanced.

In the first reaction zone, the following operation procedure is preferred: the polycarbonate oligomer, the polyorganosiloxane, and the organic solvent are supplied and mixed, then the catalyst is supplied as required, and subsequently, the caustic alkali is supplied and mixed into the mixture. The compatibility between the polyorganosiloxane and the polycarbonate oligomer is low, and hence a situation in which the reaction between the polycarbonate oligomer and the polyorganosiloxane locally advances can be avoided by supplying the catalyst and the caustic alkali after mixing the polyorganosiloxane and the polycarbonate oligomer in advance. A temperature in the first reaction zone is preferably set to from 10° C. to 35° C.

### [Second Reaction Zone]

The second reaction zone specified in the present invention is intended to introduce the reaction liquid obtained from the first reaction zone containing the polycarbonate oligomer that has reacted with the polyorganosiloxane (PC-POS oligomer reaction liquid), the end terminator represented by the general formula (I), the alkaline aqueous solution of the dihydric phenol, and the caustic alkali to perform a reaction in the second reaction zone. The reaction in the second reaction zone is intended to subject the PC-POS oligomer and the dihydric phenol to polycondensation to set the viscosity-average molecular weight of the PC-POS to be obtained to a target value. The second reaction zone is described below.

<Raw Materials to be used in Second Reaction Zone>

### (i) PC-POS Oligomer Reaction Liquid

The PC-POS oligomer reaction liquid obtained from the first reaction zone described above is used.

### (ii) Alkaline Aqueous Solution of Dihydric Phenol

The alkaline aqueous solution of the dihydric phenol to be used in the second reaction zone is used for being subjected to the polycondensation reaction with the polycarbonate oligomer obtained from the first reaction zone to increase its molecular weight.

The dihydric phenol to be used is the dihydric phenol represented by the general formula (1) to be used at the time of the production of the polycarbonate oligomer, and a dihydric phenol particularly preferred as the dihydric phenol represented by the general formula (1) may be, for example, bisphenol A.

In addition, the alkaline aqueous solution, such as sodium hydroxide or potassium hydroxide, to be used at the time of the production of the polycarbonate oligomer can be preferably used as the alkaline aqueous solution, and with regard to the concentration of the caustic alkali, such as sodium hydroxide or potassium hydroxide, in the alkaline aqueous solution, a solution having a concentration of from 1 mass % to 15 mass % is similarly preferably used. The content of the dihydric phenol in the alkaline aqueous solution is similarly selected from the range of from 0.5 mass % to 20 mass %.

(iii) End Terminator

In the second reaction zone, the end terminator represented by the following general formula (I) is introduced for adjusting the molecular weight of the PC-POS after the completion of the reaction.

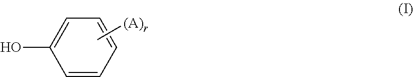

Examples of the end terminator represented by the general formula (I) include the same examples as those described above, and for example, phenol, p-cresol, p-tert-butylphenol, p-tert-octylphenol, p-cumylphenol,and p-phenylphenol. Among them, at least one selected from p-tert-butylphenol, p-cumylphenol, and p-phenylphenol is preferred, and p-tert-butylphenol is more preferred.

### (iv) Caustic Alkali

In the second reaction zone, the alkaline aqueous solution of the dihydric phenol and the PC-POS oligomer reaction liquid are subjected to the polycondensation reaction. In the reaction, the dihydric phenol becomes an alkali metal salt in the alkaline aqueous solution of the dihydric phenol, and the alkali metal salt of the dihydric phenol and a chloroformate group of the PC-POS oligomer dissolved in the organic solvent are subjected to a desalitation at an interface between an organic phase and an aqueous phase to be subjected to polycondensation, thereby increasing the molecular weight of the oligomer. The interfacial polycondensation reaction advances under an alkaline condition. Accordingly, in order that the reaction maybe accelerated, the reaction needs to be performed by adding the caustic alkali, such as sodium hydroxide or potassium hydroxide.

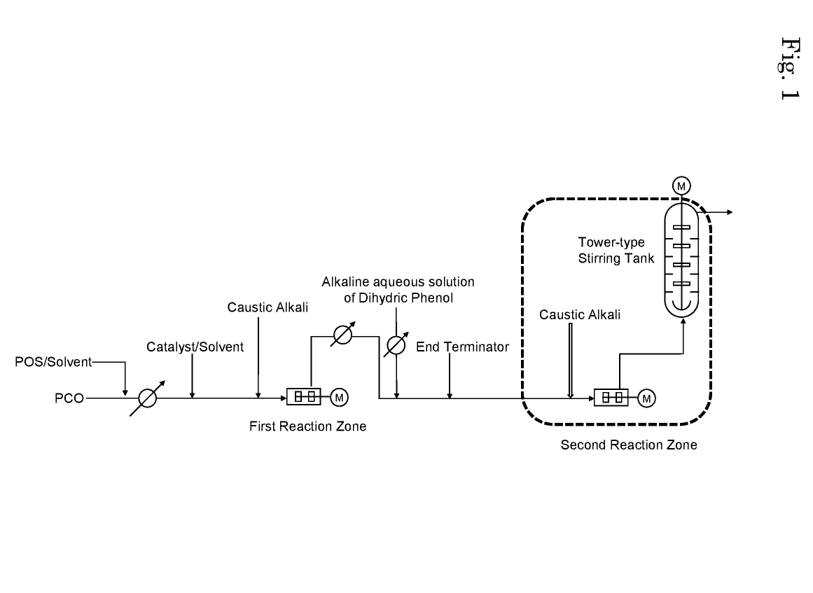

The total amount of the usage amount of the caustic alkali to be introduced from the introduction port leading to the second reaction zone needs to be introduced from the introduction port leading to the second reaction zone (the introduction port of a reactor to be used first when a plurality of reactors are used) as illustrated in FIG. 1. It is not preferred to introduce part of the caustic alkali in the middle of the second reaction zone in a divided manner because when the polycondensation reaction liquid (emulsion solution containing the PC-POS) to be obtained is separated into an aqueous phase and an organic phase containing the PC-POS, oil-water separability deteriorates to worsen the productivity of the PC-POS.

The caustic alkali to be introduced from the introduction port of the second reaction zone preferably has a concentration of from 5 mass % to 30 mass %, and the caustic alkali is preferably supplied so that the concentration of the caustic alkali in the aqueous phase of the reaction liquid may be from 0.05 normal (N) to 0.7 N.

### (v) Other Raw Material

The same catalyst used in the first reaction zone can be used for accelerating the polycondensation reaction, and a preferred examples and the way of introducing thereof are also the same.

<Reactor to be used in Second Reaction Zone and Reaction Condition>

In the second reaction zone, the reaction can be completed with only one reactor depending on the ability of the reactor to be used. However, the second reaction zone can be obtained by further building a plurality of reactors, such as a second reactor and a third reactor subsequent to the first reactor, as required. A stirring tank, a tower-type stirring tank with a vertical multistage impeller, a stationary tank, a static mixer, a line mixer, an orifice mixer, a pipe, or the like can be used as the reactor to be used in the second reaction zone. Those reactors may be arbitrarily combined to be used as a plurality of reactors.

The method of producing a PC-POS of the present invention can be performed continuously or in a batch. When the PC-POS is produced in a batch, first, in the reactor to be used as the first reaction zone, the PC-POS oligomer is produced by performing the reaction between the polycarbonate oligomer having a weight-average molecular weight of less than 5,000 and the polyorganosiloxane through the use of the polycarbonate oligomer, the polyorganosiloxane, the catalyst (for example, TEA), and the caustic alkali. Next, it is desired that the caustic alkali and the alkaline aqueous solution of the dihydric phenol, and the end terminator represented by the general formula (I) be loaded into the same reactor to set a condition in the reactor to the condition of the second reaction zone (specifically a caustic alkali concentration of from 0.05 N to 0.7 N). In other words, it is desired that the conditions of both the reaction zones, i.e., the first reaction zone and the second reaction zone be sequentially set by regulating the reaction condition through the use of the same reactor.

A temperature in the second reaction zone is preferably set to from 20° C. to 35° C. In particular, when the temperature in the second reaction zone is more than 35° C., there arises a risk in that the end hydroxyl group ratio of a molded article increases to increase the YI value of the molded article. Accordingly, the temperature is preferably set to 35° C. or less.

In order to set the temperature in the second reaction zone to 35° C. or less, a heat exchanger is preferably placed at the outlet of the first reaction zone to cool the PC-POS oligomer reaction liquid obtained from the first reaction zone. The temperature of the reaction liquid at the outlet of the heat exchanger is typically from 10° C. to 25° C., though the temperature can be arbitrarily set so that the temperature in the second reaction zone may not be more than 35° C.

A reduction in temperature of the alkaline aqueous solution of the dihydric phenol to be introduced into the second reaction zone is also preferably used as means for setting the temperature in the second reaction zone to 35° C. or less. The placement of a heat exchanger as required is effective in reducing the temperature of the alkaline aqueous solution of the dihydric phenol, and the temperature of the alkaline aqueous solution of the dihydric phenol at the outlet of the heat exchanger is typically from 15° C. to 30° C., though the temperature can be arbitrarily set in consideration of the following conditions: the temperature in the second reaction zone is not more than 35° C.; and the dihydric phenol and the caustic alkali are not deposited.

[Step after Polycondensation Reaction]

### (i) Separating Step

The polycondensation reaction liquid containing the PC-POS after the completion of the polycondensation reaction is taken out of the outlet of the second reaction zone. The polycondensation reaction liquid obtained from the second reaction zone is in an emulsion state, and the emulsion needs to be separated into the organic phase containing the PC-POS and the aqueous phase. To that end, an inert organic solvent, such as methylene chloride, is added to the polycondensation reaction liquid obtained from the second reaction zone to moderately dilute the liquid, and then the diluted liquid is separated into the aqueous phase and the organic phase containing the PC-POS by an operation, such as settled or centrifugal separation.

### (ii) Washing Step

The organic phase containing the PC-POS thus separated is subjected to a washing treatment with, for example, an alkaline aqueous solution, an acidic aqueous solution, and pure water in order that a residual monomer, a catalyst, an alkaline substance, and the like serving as impurities may be removed. The washed mixture is separated into an organic phase containing a purified PC-POS and an aqueous phase with a centrifugal separator or a settled separation tank.

(iii) Concentrating Step

The organic phase containing the purified PC-POS subjected to the washing treatment is concentrated with a kneader, a powder bed granulator, a hot water granulator, or the like so as to have a concentration in a range proper for efficient powdering or granulation, preferably a concentration of from 10 mass % to 45 mass % .

### (iv) Powdering Step, Granulating Step, and Drying Step

The organic phase containing the purified PC-POS obtained in the concentrating step is powdered and granulated by a known powdering step or granulation method, such as a kneader, a granulator of powder bed, or a granulator using hot water. The resultant powdered product and granulated product each contain the used organic solvent, such as methylene chloride, at from 1 mass % to 8 mass %, and are hence desirably further subjected to heat drying, vacuum drying, or the like so that the content of the residual organic solvent may be 1,000 ppm or less.

The production method of the present invention is excellent in oil-water separability at the time of the separation of the polycondensation reaction liquid into the organic phase and the aqueous phase. Accordingly, a method of producing a PC-POS providing satisfactory production efficiency can be provided.

The oil-water separability can be evaluated by, for example, measuring a moisture concentration in the organic phase, and the concentration is measured by, for example, introducing a gas produced by heating the organic phase to 120° C. into a Karl Fischer moisture content-measuring apparatus.

Although an upper limit for the moisture concentration in the organic phase varies depending on the ability of a subsequent washing step, it is effective to remove the aqueous phase containing impurities from the organic phase to the extent possible in the oil-water separation after the polycondensation reaction from the viewpoint of production efficiency, and specifically, the concentration is preferably 10,000 ppm by mass or less, more preferably 5,000 ppm by mass or less, still more preferably 2,500 ppm by mass or less.

The content of a polyorganosiloxane moiety in the PC-POS obtained by the method of producing a polycarbonate-polyorganosiloxane copolymer of the present invention is preferably from 1 mass % to 20 mass %, more preferably from 3 mass % to 12 mass %, still more preferably from 3 mass % to 9 mass % from the viewpoint of, for example, a balance among a flame retardancy-imparting effect, an impact resistance-imparting effect, and economical efficiency.

The viscosity-average molecular weight of the PC-POS obtained by the method of producing a polycarbonate-polyorganosiloxane copolymer of the present invention is preferably from 10,000 to 30,000, and is more preferably from15, 000 to 20, 000 from the viewpoint of handling.

The viscosity-average molecular weight (Mv) of a polycarbonate resin is calculated from the following expression by using a limiting viscosity [η] determined by measuring the viscosity of a methylene chloride solution at 20° C. with an Ubbelohde-type viscometer.

[η]=1.23×10⁻⁵ Mv^{0.83}

The PC-POS obtained by the method of producing a polycarbonate-polyorganosiloxane copolymer of the present invention can be mixed with a polycarbonate resin except the PC-POS at an arbitrary ratio to provide a polycarbonate resin composition containing the PC-POS.

The polycarbonate resin to be mixed is not particularly limited, and various known polycarbonate resins except the PC-POS can each be used.

An additive, such as an antioxidant, a UV absorber, a flame retardant, a release agent, an inorganic filler (for example, a glass fiber, talc, titanium oxide, or mica), a colorant, or a light-diffusing agent, can be used in the PC-POS or the polycarbonate resin composition containing the PC-POS in accordance with characteristics required in a target application. The PC-POS or the resin composition containing the PC-POS can be molded into a molded body by any one of various molding methods, such as injection molding, injection compression molding, extrusion molding, and blow molding.

The molded body obtained by molding the PC-POS or the resin composition containing the PC-POS has been expected to be widely utilized in various fields, such as electrical and electronic fields, and an automobile field. In particular, the molded body can be utilized as, for example, a material for the casing of a cellular phone, a mobile personal computer, a digital camera, a video camera, an electric power tool, or the like, or a material for other articles for daily use.

### EXAMPLES

The present invention is described in more detail below by way of examples. The present invention is not limited by those examples. The oil-water separability of a polycondensation reaction liquid in each of Example and Comparative Example was evaluated by measuring a moisture concentration in an organic phase after the liquid had been left to stand still for 60 minutes. A larger moisture concentration means that the oil-water separability is poorer. The moisture concentration was measured by introducing a gas produced by heating the organic phase to 120° C. into a Karl Fischer moisture measuring apparatus (Model CA-200 manufactured by Mitsubishi Chemical Analytech Co., Ltd.).

### Example 1

### (Production of Polycarbonate Oligomer Solution)

To 5.6 mass % aqueous sodium hydroxide, sodium dithionite was added in an amount of 2,000 ppm by mass relative to bisphenol A to be dissolved later, and bisphenol A was then dissolved therein so that the concentration of bisphenol A became 13.5 mass %, to thereby prepare a solution of bisphenol A in aqueous sodium hydroxide.

The solution of bisphenol A in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion, and cooling water was passed through the jacket to keep the reaction liquid at a temperature of 40° C. or less.

The reaction liquid that had exited the tubular reactor was continuously introduced into a baffled tank-type reactor provided with a sweptback blade and having an internal volume of 40 L, and then, 2.8 L/hr of the solution of bisphenol A in aqueous sodium hydroxide, 0.07 L/hr of 25 mass % aqueous sodium hydroxide, 17 L/hr of water, and 0.64 L/hr of a 1 mass % triethylamine aqueous solution were further added to the reactor to perform a reaction. The reaction liquid overflown from the tank-type reactor was continuously taken out and left to stand still to separate and remove an aqueous phase, and a methylene chloride phase (polycarbonate oligomer solution) was then collected.

The concentration of the thus obtained polycarbonate oligomer solution (methylene chloride solution) was 318 g/L, and the concentration of a chloroformate group thereof was 0.75 mol/L. In addition, the polycarbonate oligomer had a weight-average molecular weight (Mw) of 1,190.

The weight-average molecular weight (Mw) was measured as a molecular weight (weight-average molecular weight: Mw) in terms of standard polystyrene by GPC (column: TOSOH TSK-GEL MULTIPORE HXL-M (two)+Shodex KF801 (one), temperature: 40° C., flow rate: 1. 0 ml/min, detector: RI) with tetrahydrofuran (THF) as a developing solvent.

### (First Reaction Zone)

After 20 liters/hr of the resultant polycarbonate oligomer solution (PCO) and 9.5 liters/hr of methylene chloride had been mixed, a 20 mass % solution of an allylphenol terminal-modified polydimethylsiloxane (PDMS) having a number (n) of repetitions of a dimethylsiloxane unit of 90 in methylene chloride (PDMS/MC) was added at 2.6 kg/hr to the mixture. After that, the materials were mixed well with a static mixer, and then the liquid mixture was cooled to from 19° C. to 22° C. with a heat exchanger.

0.5 kg/hr of a 1 mass % solution of triethylamine in methylene chloride was added to the cooled liquid mixture, and the liquids were mixed. After that, 1.4 kg/hr of 8.0 mass % aqueous sodium hydroxide was added to the mixture, and the whole was supplied to T.K. Pipeline Homomixer 2SL Type (manufactured by PRIMIX Corporation) serving as a first reaction zone [line mixer used as the first reaction zone], the homomixer provided with a turbine blade having a diameter of 43 mm and a turbine blade having a diameter of 48 mm, the homomixer having an internal volume of 0.3 liter. The polycarbonate oligomer and the polydimethylsiloxane were caused to react with each other under stirring at a number of revolutions of 4, 400 rpm to provide a reaction liquid containing the polycarbonate oligomer that had reacted with the polydimethylsiloxane (PC-PDMS oligomer reaction liquid).

### (Second Reaction Zone)

Subsequently, the resultant PC-PDMS oligomer reaction liquid was cooled to from 17° C. to 20° C. with a heat exchanger. 10.2 kg/hr of a solution of bisphenol A in aqueous sodium hydroxide, 1.5 kg/hr of 15 mass % aqueous sodium hydroxide, and 1.3 kg/hr of an 8 mass % solution of p-t-butylphenol in methylene chloride were added to the PC-PDMS oligomer reaction liquid after the cooling. After that, the mixture was supplied to T.K. Pipeline Homomixer 2SL Type (manufactured by PRIMIX Corporation) serving as a second reaction zone [line mixer used as the first reactor of the second reaction zone], the homomixer provided with a turbine blade having a diameter of 43 mm and a turbine blade having a diameter of 48 mm, the homomixer having an internal volume of 0.3 liter, followed by the performance of a polymerization reaction under stirring at a number of revolutions of 4,400 rpm. A caustic alkali to be introduced into the second reaction zone was the 15 mass % aqueous sodium hydroxide, and the total amount of the usage amount thereof was introduced from an introduction port leading to the second reaction zone (introduction port of the T.K. Pipeline Homomixer 2SL Type used as the first reactor of the second reaction zone).

Further, in order for the reaction to be completed, the resultant was supplied to a tower-type stirring tank with a jacket [used as the second reactor of the second reaction zone], the tank having an internal volume of 50 liters and with three paddle blades, and polycondensation was performed. Thus, a polycondensation reaction liquid containing a polycarbonate-polydimethylsiloxane was obtained. Cooling water having a temperature of 15° C. was flowed through the jacket of the tower-type stirring tank, and the outlet temperature of the polycondensation reaction liquid was set to 35° C.

35 L of the polycondensation reaction liquid and 10 L of methylene chloride for dilution were loaded into a 50-liter washing tank provided with a baffle board and a paddle-type stirring blade, and were stirred at 240 rpm for 10 minutes. After that, the mixture was left to stand still for 1 hour to be separated into an organic phase containing the PC-PDMS, and an aqueous phase containing excessive amounts of bisphenol A and sodium hydroxide. A moisture concentration in the organic phase 60 minutes after the initiation of the still standing was measured. As a result, the concentration was 2,000 ppm by mass.

The solution containing the PC-PDMS in methylene chloride (organic phase) thus obtained was sequentially washed with 0.03 mol/L aqueous sodium hydroxide and 0.2 mol/L hydrochloric acid in amounts of 15 vol % each with respect to the solution. Next, the solution was repeatedly washed with pure water so that an electric conductivity in an aqueous phase after the washing became 0.1 mS/m or less.

The solution of the PC-PDMS in methylene chloride thus obtained was concentrated, and was then pulverized and dried under reduced pressure at 120° C.

The resultant polycarbonate-polydimethylsiloxane copolymer (PC-PDMS) had a polydimethylsiloxane moiety content of 6 mass % and a viscosity-average molecular weight (Mv) of 17,000.

### Comparative Example 1

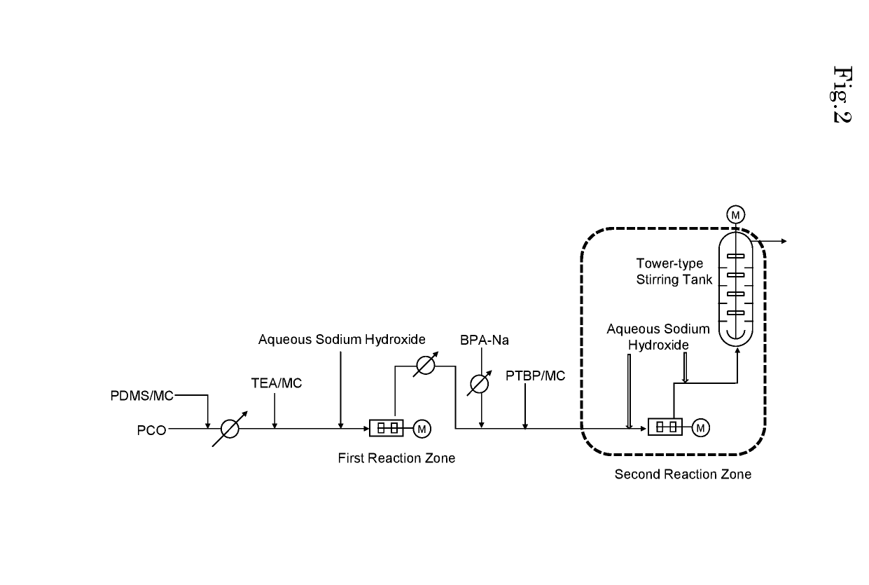

In Example 1, 15 mass % aqueous sodium hydroxide introduced into the second reaction zone was introduced into the introduction port leading to the second reaction zone and the outlet of the first reactor of the second reaction zone at flow rates of 0.5 kg/hr and 1.0 kg/hr, respectively. A polycondensation reaction was performed in the same manner as in Example 1 except that the aqueous sodium hydroxide was introduced in a divided manner as described above. A schematic view of a reaction process from the first reaction zone to the second reaction zone is illustrated in FIG. 2.

35 L of a polycondensation reaction liquid obtained by the reaction and 10 L of methylene chloride for dilution were loaded into a 50-liter washing tank provided with a baffle board and a paddle-type stirring blade, and were stirred at 240 rpm for 10 minutes. After that, the mixture was left to stand still for 1 hour. As a result, an organic phase and an aqueous phase did not separate from each other at all even after the lapse of 60 minutes from the initiation of the still standing.

### INDUSTRIAL APPLICABILITY

The method of producing a polycarbonate-polyorganosiloxane copolymer of the present invention provides satisfactory oil-water separability of a polycondensation reaction liquid, and hence can efficiently provide the polycarbonate-polyorganosiloxane copolymer.

1. A method of producing a polycarbonate-polyorganosiloxane copolymer, comprising:
a first reaction zone into which a polycarbonate oligomer, a polyorganosiloxane, and a caustic alkali are introduced to provide a reaction liquid containing the polycarbonate oligomer that has reacted with the polyorganosiloxane; and
a second reaction zone into which the reaction liquid obtained from the first reaction zone, an alkaline aqueous solution of a dihydric phenol, an end terminator represented by the following general formula (I), and the caustic alkali are introduced to provide a polycondensation reaction liquid,
wherein a total amount of the caustic alkali to be introduced into the second reaction zone is introduced from an introduction port of the second reaction zone to perform a reaction: 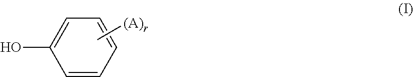
wherein
A represents a linear or branched alkyl group having 1 to 14 carbon atoms, or a phenyl group-substituted alkyl group, and r represents from 0 to 5.

2. The method of producing a polycarbonate-polyorganosiloxane copolymer according to claim 1, wherein the dihydric phenol comprises a dihydric phenol represented by the following general formula (1): 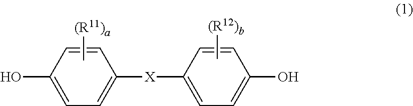
wherein R¹¹ and R¹² each independently represent an alkyl group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O—, or —CO—, and a and b each independently represent an integer of from 0 to 4.

3. The method of producing a polycarbonate-polyorganosiloxane copolymer according to claim 1, wherein the polyorganosiloxane comprises a polyorganosiloxane represented by at least one selected from the following general formulae (2), (3), and (4): 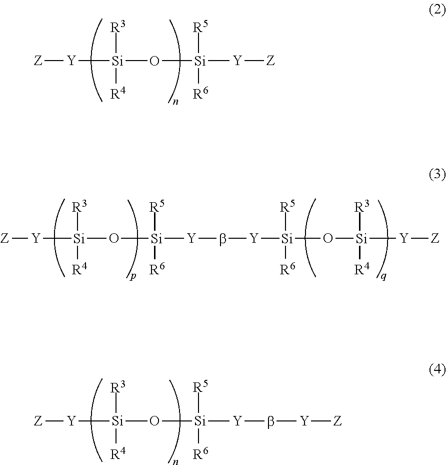
wherein
R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³, R⁴, R⁵, or R⁶ may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Y may be identical to or different from each other, the R⁷ represents a single bond, a linear, branched, or cyclic alkylene group, an aryl-substituted alkylene group, a substituted or unsubstituted arylene group, or a diarylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, Z represents a hydrogen atom or a halogen atom, and a plurality of Z may be identical to or different from each other, β0 represents a divalent group derived from a diisocyanate compound, or a divalent group derived from a dicarboxylic acid or a halide of a dicarboxylic acid, p and q each represent an integer of 1 or more, and a sum of p and q is from 20 to 500, and n represents an average number of repetitions of from 20 to 500.

4. The method of producing a polycarbonate-polyorganosiloxane copolymer according to claim 1, wherein the end terminator comprises at least one selected from p-t-butylphenol, p-cumylphenol, and p-phenylphenol.

5. The method of producing a polycarbonate-polyorganosiloxane copolymer according to claim 1, wherein the dihydric phenol comprises bisphenol A.

6. The method of producing a polycarbonate-polyorganosiloxane copolymer according to claim 1, wherein the caustic alkali comprises sodium hydroxide and the alkaline aqueous solution comprises aqueous sodium hydroxide.

7. The method of producing a polycarbonate-polyorganosiloxane copolymer according to claim 1, wherein a content of a polyorganosiloxane moiety in the polycarbonate-polyorganosiloxane copolymer is from 1 mass % to 20 mass %.

8. The method of producing a polycarbonate-polyorganosiloxane copolymer according to claim 1, wherein the polycarbonate-polyorganosiloxane copolymer has a viscosity-average molecular weight of from 10,000 to 30,000.

9. The method of producing a polycarbonate-polyorganosiloxane copolymer according to claim 1, wherein a reactor to be used in the first reaction zone and/or the second reaction zone comprises a line mixer.

10. The method of producing a polycarbonate-polyorganosiloxane copolymer according to claim 1, wherein the polycarbonate oligomer to be used in the first reaction zone has a weight-average molecular weight of less than 5,000.
